(19) United States
(12) Patent Application Publication
(10) Pub. No.: US 2025/0300370 A1
(43) Pub. Date: Sep. 25, 2025

(54) Switchable Broadband Antenna

(71) Applicant: Siemens Aktiengesellschaft, Muenchen (DE)

(72) Inventors: Andreas DEMMER, Wien (AT); Lukas Walter MAYER, Wien (AT); Leopold RESEL, Wien (AT); Martin SCHIEFER, Pölten (AT)

(21) Appl. No.: 19/083,618

(22) Filed: Mar. 19, 2025

(30) Foreign Application Priority Data
Mar. 21, 2024 (EP) 24165238

(51) Int. Cl. H01Q 21/26; H01Q 3/24

(52) U.S. Cl. CPC H01Q 21/26; H01Q 3/24

(57) ABSTRACT

A switchable broadband antenna includes an antenna feed point for feeding in an input signal and further includes four antenna paths connected in parallel with respect to the antenna feed point, wherein each of the four antenna paths include a matching circuit, a divider circuit, a control circuit and a dipole antenna element, where in each case two dipole antenna elements are arranged in a first polarization direction, the respective divider circuit has two divider lines between an input point and two output points, the control circuit has two electronically controllable impedances, and where the two electronically controllable impedances are each arranged in opposite directions.

### BACKGROUND OF THE INVENTION

### 1. Field of the Invention

The present invention relates to antennas and, more particularly, to invention relates to a switchable broadband antenna.

### 2. Description of the Related Art

Broadband data transmissions using numerous frequency bands are to be used for fifth or sixth generation wireless communications and the latest generation Wireless Local Area Network (WLAN).

Herein, such broadband data transmissions should be well matched to a wide variety of applications and should have switchable radiation patterns to match applications optimally to an environment.

In addition, it should be possible to integrate antennas, i.e., they should not have any external antennas and should be easy to manufacture.

To date, not all these requirements are met by a single antenna in the prior art. Currently, broadband antennas have a fixed radiation pattern, wherein the radiation pattern can be switched between different antennas (“antenna diversity”).

### SUMMARY OF THE INVENTION

In view of the foregoing, it is therefore an object of the invention to provide a broadband antenna with a switchable pattern that is easy to manufacture and simple to integrate.

This and other objects and advantages are achieved in accordance with the invention by a switchable broadband antenna comprising an antenna feed point for feeding in an input signal and further comprising four antenna paths connected in parallel with respect to the antenna feed point, in each case having a matching circuit, a divider circuit, a control circuit and a dipole antenna element, where in each case two dipole antenna elements are arranged in a first polarization direction, and the further two dipole antenna elements are arranged in a second polarization direction aligned normally to the first polarization direction.

In accordance with the invention, the respective matching circuit is configured to establish impedance matching for the input signal between the antenna feed point and the divider circuit, the respective divider circuit has two divider lines between an input point and two output points of the divider circuit with a common reference surface, and the divider circuit is further configured to symmetrically divide a signal provided to the input point via the matching circuit and to supply the divided signal to the respective output point of the divider circuit which is connected to the respective dipole antenna element. In addition, the control circuit has two electronically controllable impedances for which, in each case, at least two predetermined reflection factors can be set, where in each case one of the two divider lines of the divider circuit is connected to the reference surface of the divider circuit via one of the two electronically controllable impedances, and the control circuit is configured to provide respective control voltages to the respective electronically controllable impedances so that different reflection factors are set between the two electronically controllable impedances to switch the signal provided by the matching circuit and thus control the antenna pattern of the switchable broadband antenna.

This ensures that the antenna achieves a very broadband performance across the frequency range, such as 4-7 GHz, and can switch the dipoles to obtain an adjustable antenna pattern.

It is advantageous for each of the two dipole antenna elements to be arranged at a distance of approximately half the wavelength or an integer multiple of half the wavelength of the input signal.

In difficult environments, the radiation pattern can be switched automatically, i.e., adaptively. The existing polarization modes can increase diversity compared to separate antennas. Switchable radiation patterns are particularly advantageous for different applications. In addition, the radiation pattern can only be adjusted after the antenna has been installed, hence facilitating operation and maintenance and offering a high degree of diversity.

Furthermore, at least two such groups can be used to generate signals that offer a high degree of polarization and spatial diversity. For example, a PIN diode, varactor diode, field effect transistor or MEMS (microelectromechanical system, for example, a radio-frequency switch) with a corresponding circuit can be used as an electronically controllable impedance.

The two electronically controllable impedances each switch between at least two specified reflection states of the controllable impedance with respective different reflection factors using the control voltages provided by the control circuit.

The respective control voltage is in direct proportion to the desired impedance, which is used to set a respective reflection factor at the location of the controllable impedance on the line. The reflection factors on both divider lines serve to control the dipole antenna accordingly and thus obtain an adjustable antenna pattern.

The control voltage required in each case is defined in advance in connection with the controllable impedance realized in each case and optionally with a circuit required to actuate the selected controllable impedance, which is included in the control circuit.

The term reflection factor or reflection coefficient refers to the amplitude ratio between the reflected and incident waves at the transition to another propagation medium, such as a change in the characteristic impedance in a line or at an interference point that can be created by the controllable impedance. However, the reflection factors of the respective controllable impedance can also in each case lie in a range between “−1” and “+1”, which represent a short circuit or an open circuit to ensure that the reflections of the signal in the divider lines overlap constructively or destructively.

A reflection factor of “−1” corresponds to a short circuit, i.e., a total reflection with a phase inversion at the short-circuited end of a line. A reflection factor of “+1” corresponds to an open circuit, i.e., a total reflection without phase inversion at the open end of a line. A reflection factor of “0” corresponds to ideal adaptation to the characteristic impedance of the line, i.e., there is no reflection.

In a preferred exemplary embodiment, more than two predetermined reflection factors can also be set, for example three, four or more predetermined reflection factors. For example, with three specified reflection states of the controllable impedance or the reflection factors thereof, it is possible to switch between the “logic” states “−1”, “0” and “+1” for each controllable impedance.

A “logic” state for the controllable impedance corresponds to each specified reflection state or reflection factor of the controllable impedance, which comprises a reflection magnitude and a reflection phase value. This can be used to obtain an even more variably adjustable antenna pattern. Preferably, there is a distance of greater than one between these two reflection states in the magnitude of the reflection factors. This can be achieved in a simple way because the two reflection factors of the electronically controllable impedances differ, for example, in the preliminary sign, such as a reflection factor of “−1” and “+1”, i.e. an inverse phase between the electronically controllable impedances. Optionally, herein the controllable reflection factor can be approximately equal in magnitude, and preferably have a magnitude of greater than 0.5.

In the present context, a “counter-rotating arrangement” of PIN diodes as electronically controllable impedances should be understood as meaning that the two reflection factors of the electronically controllable impedances differ by the preliminary sign, i.e., they cause a reflection in the signals fed into the two divider lines with a difference of 180° compared to the other signal in each case of the other divider line in each case to ensure that the reflections of the signal in the two divider lines in each case overlap constructively or destructively.

In other words, signals fed in at the two divider lines are reflected in opposite directions at the electronically controllable impedances; this can be achieved with reflection factors of the electronically controllable impedances in the respective divider lines that in each case have the opposite magnitude.

The control circuit provides the respective electronically controllable impedance with predefined control voltages, for example, which configure the electronically controllable impedance such that a predetermined reflection factor is set. for example “−1” and “+1”.

In an embodiment of the invention, in the respective antenna path, the divider circuit is realized on a circuit carrier with a first side and a second side, and the two divider lines are arranged on the first side and the common reference surface is arranged on the second side. This significantly simplifies the construction of the antenna.

A conventional circuit carrier material for a double-sided printed circuit board, such as FR4, can be used.

In another embodiment of the invention, in the respective antenna path, the dipole antenna elements are also arranged on the circuit carrier of the divider circuit. This further simplifies the construction of the antenna.

In a further embodiment of the invention, in the respective antenna path, the dipole antenna elements are arranged on the second side of the circuit carrier. This significantly simplifies the construction of the antenna.

In another embodiment of the invention, in the respective antenna path, the dipole antenna elements are connected to the reference surface of the divider circuit. This significantly simplifies the construction of the antenna.

In a still further embodiment of the invention, in the respective antenna path, the reference surface of the divider circuit has an electrically non-conductive dividing strip, which extends from between the output points of the two divider lines to the input point. This obtains a particularly high degree of symmetry of the antenna, which has a positive effect on a homogeneous antenna diagram.

In an embodiment of the invention, a feed circuit for feeding and controlling the two electronically controllable impedances of the control circuit is inserted into the respective antenna path. This makes it particularly easy to provide the control voltage for controlling the electronically controllable impedances.

It is clear that in each case different control voltages are used for the two electronically controllable impedances used, depending on whether they are operated in the forward or reverse direction, since the electronically controllable impedances are operated with different polarity (conducting or blocking).

In a further embodiment of the invention, the feed circuit in the divider circuit is inserted before the feed point into the respective antenna path. This makes it particularly easy to provide the control voltage for controlling the electronically controllable impedances.

In yet another embodiment of the invention, in the respective antenna path, the output points of the divider circuit are in each case connected to the dipole antenna element via an ohmic resistor. This makes it easy to influence the antenna diagram for adaptation to an application. The resistor makes it particularly easy to adapt the antenna to the requirements of different applications.

In a further embodiment of the invention, more than four antenna paths are arranged connected in parallel with respect to the antenna feed point, in each case having a matching circuit, a divider circuit, a control circuit and a dipole antenna element. This can obtain an antenna that can be controlled even more flexibly with regard to the resulting radiation pattern, since correspondingly more antenna paths can be controlled individually.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

An exemplary embodiment of the invention is now explained in more detail with reference to the following figures, in which:

FIG. 1 is an illustration of a circuit carrier with an antenna in accordance with the invention;

FIG. 2 is an illustration of an equivalent circuit diagram for an antenna element of the antenna in accordance with the invention;

FIG. 3a is an illustration with a feed point of the antenna in accordance with the invention;

FIG. 3b is an illustration of the circuit carrier at the transition between a matching circuit and a feed circuit in accordance with the invention;

FIG. 3c is an illustration of simulated field strengths of the circuit carrier in the area of an antenna element in accordance with the invention;

FIG. 3d is an illustration of a divider circuit in accordance with the invention;

FIGS. 4a to 4d are radiation diagrams of the antenna with different radiation patterns in accordance with the invention;

FIGS. 5a and 5b are pass-through diagrams of the antenna with different radiation configurations in accordance with the invention;

FIGS. 6a and 6b are insulation diagrams of the antenna in different radiation configurations in accordance with the invention;

FIGS. 7a and 7b are emitted power diagrams of the antenna in different radiation configurations in accordance with the invention;

FIGS. 8a to 8f are radiation diagrams of the antenna at different frequencies in accordance with the invention;

FIGS. 9a and 9b simulated field strength distributions of the antenna in different radiation configurations in accordance with the invention; and

FIGS. 9c and 9d are detailed enlargements of simulated field strength distributions depicted in FIGS. 9a and 9b.

### DETAILED DESCRIPTION OF THE EXEMPLARY EMBODIMENTS

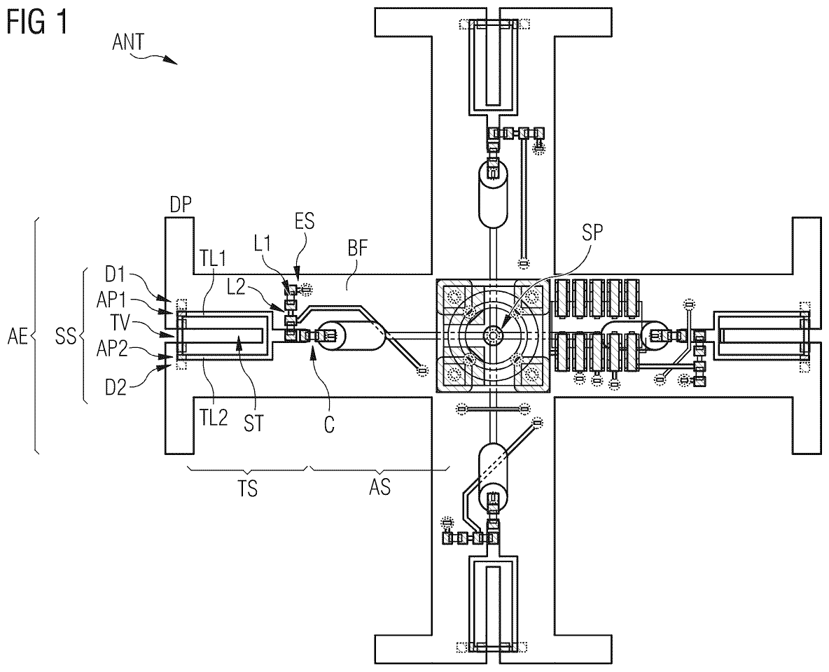

FIG. 1 shows a circuit with a switchable broadband antenna ANT according to the invention. The antenna ANT has an antenna feed point SP for feeding in an input signal, for example, in the form of a corresponding radio-frequency connector.

The antenna ANT further comprises four antenna paths AE connected in parallel with respect to the antenna feed point. The antenna paths AE each have a matching circuit AS, a divider circuit TS, a control circuit SS and a dipole antenna element DP. In each case, two dipole antenna elements are arranged in a first polarization direction and at a distance from one another of approximately an integer multiple of half the wavelength of the input signal.

The further two dipole antenna elements are arranged in a second polarization direction aligned normally to the first polarization direction, and at a distance from one another of approximately an integer multiple of half the wavelength of the input signal. The dipole antenna DP has differential feed points on its antenna elements.

The electronically controllable impedances D1, D2 forming PIN diodes each activate one of the two signal paths of the divider circuit TS and deactivate the other one. This makes it possible to decide on the direction in which the signal is supplied to the differential feed point of the antenna ANT.

In one embodiment, two electronically controllable impedances are used of which one or the other is activated and switched as a short circuit. Herein, substantially, one of the signal paths, i.e., the respective divider line TL1, TL2, is deactivated because, starting from the activated PIN diode D1, D2, line transformations generate suitable impedances at the node and at the respective side of the differential antenna feed point. Herein, on this side, an open-circuit-like impedance is generated at the node and a short-circuit-like impedance is generated at the antenna feed point.

The optimum parameters of the signal paths, such as impedances and lengths of the line segments, depend on the impedance of the feed point of the antenna and the desired input impedance at the node. The activated path then brings the signal from the nodes to the other side of the differential feed point without being influenced by the deactivated path. The selected position of the radio-frequency switches D1, D2 and the line parameters enables extremely broadband switching of the polarity to be generated.

The respective matching circuit AS is configured to establish impedance matching for the input signal between the antenna feed point SP and the divider circuit TS. The respective divider circuit TS has two divider lines TL1, TL2 between an input point EP and two output points AP1, AP2 of the divider circuit TS with a common reference surface BF. The divider circuit TS is further configured to symmetrically divide a signal provided to the input point EP via the matching circuit AS and supply the divided signal to the respective output point AP1, AP2 of the divider circuit TS, which is connected to the respective dipole antenna element DP. The two output points AP1, AP2 of the divider circuit TS are connected by a connecting line TV creating a signal divider.

The control circuit SS has two electronically controllable impedances D1, D2, where each one of the two divider lines TL1, TL2 of the divider circuit TS is connected to the reference surface BF of the divider circuit TS each via one of the two electronically controllable impedances D1, D2. The two PIN diodes D1, D2 are each arranged in opposite directions. The control circuit SS is configured to provide a DC control voltage SS to the respective electronically controllable impedances D1, D2 to switch the signal provided by the matching circuit AS and thus control the antenna pattern of the switchable broadband antenna ANT.

The antenna ANT has four antenna paths AE, which are connected in parallel. In the respective antenna path AE, the divider circuit TS is realized on a circuit carrier with a first side and a second side, for example, FR4.

The two divider lines TL1, TL2 are arranged on the first side and the common reference surface BF is arranged on the second side.

In the respective antenna path AE, the dipole antenna elements DP are also arranged on the circuit carrier of the divider circuit TS, i.e., on the second side of the circuit carrier, and the dipole antenna elements DP are connected to the reference surface BF of the divider circuit TS.

The reference surface BF of the divider circuit TS has an electrically non-conductive dividing strip ST, i.e., a slot, which extends from between the output points AP1, AP2 of the two divider lines TL1, TL2 to the input point EP.

Furthermore, a feed circuit ES for feeding and controlling the two electronically controllable impedances D1, D2 of the control circuit SS is inserted into the respective antenna path AE, in this example between the matching circuit AS and the divider circuit TS, i.e., before the feed point EP into the respective antenna path AE.

Optionally, the output points AP1, AP2 of the divider circuit TS can each be connected to the dipole antenna element DP via an ohmic resistor in the respective antenna path AE.

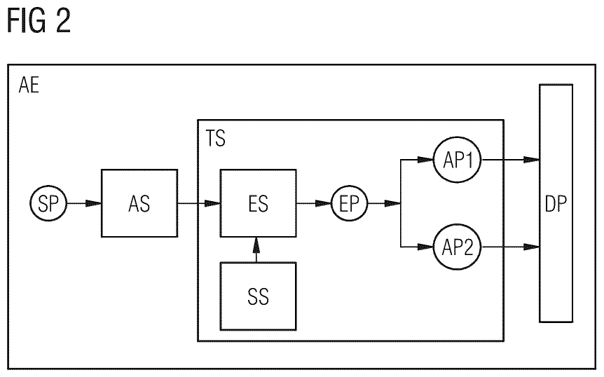

FIG. 2 illustrates an equivalent circuit diagram for an antenna element of the antenna in accordance with the invention. An input signal is fed into the antenna feed point SP.

The matching circuit AS matches the impedances between the antenna feed point SP and the divider circuit TS accordingly and also takes into account a total of four parallel antenna paths AE connected in parallel. The matching circuit AS transforms the characteristic impedance of the divider circuit TS from 50 ohms to a value of 200 ohms for a single antenna path AE.

The four antenna paths each with an input resistance of 200 ohms are connected in parallel, which in turn leads to an input resistance of 50 ohms for the antenna ANT at the antenna feed point SP.

The feed circuit ES enables the two electronically controllable impedances D1, D2 in the form of PIN diodes to be fed and controlled by a control voltage (“bias”). The control voltage is provided by the control circuit SS in the form of a DC voltage.

The divider is formed by two divider lines TL1, TL2 and a connecting line TV between the input point EP and the output points AP1, AP2. The dipole halves of the dipole DP are each connected to one of the output points AP1, AP2.

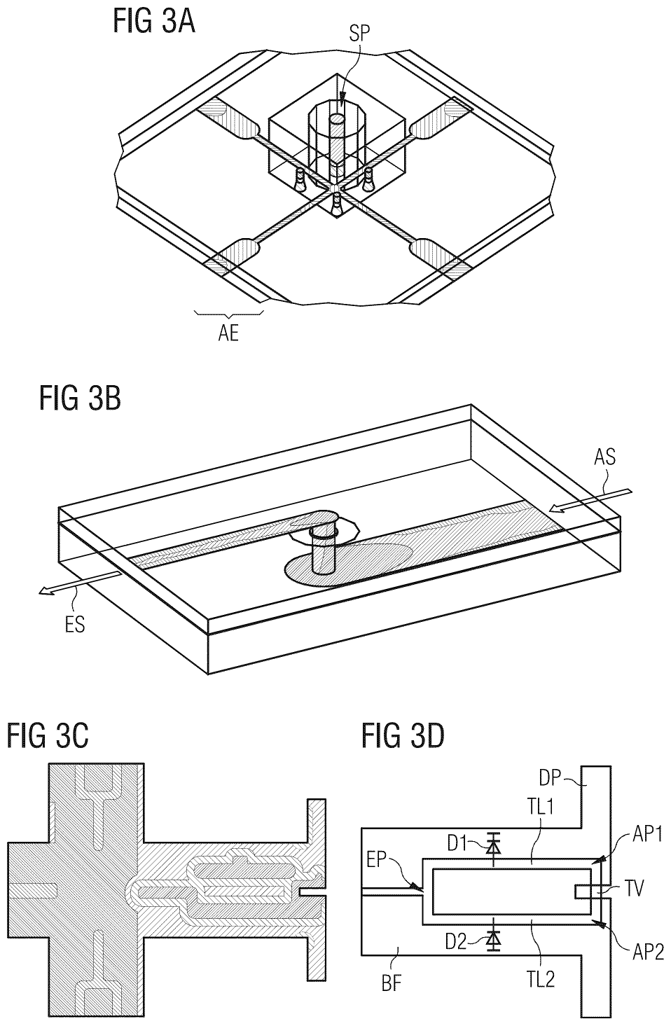

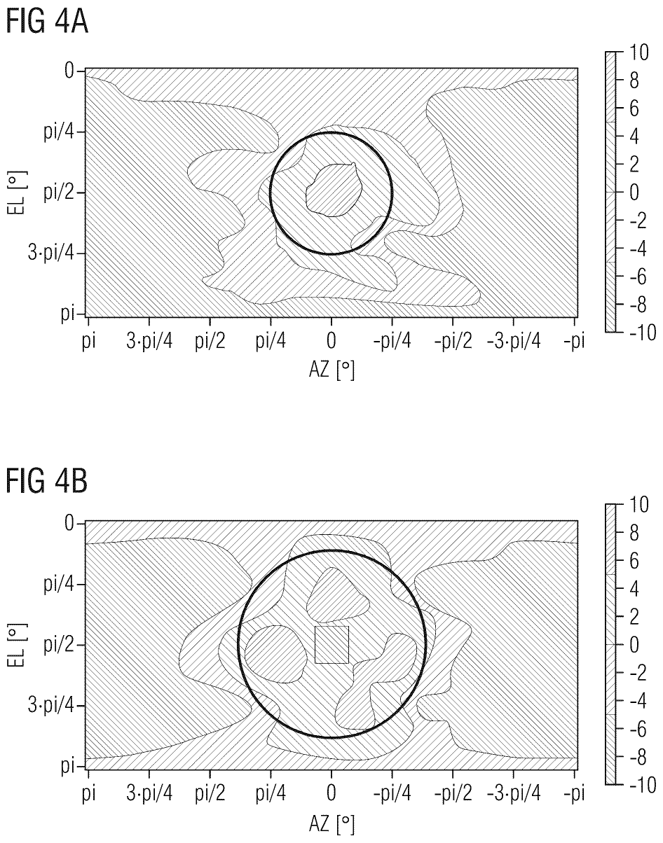

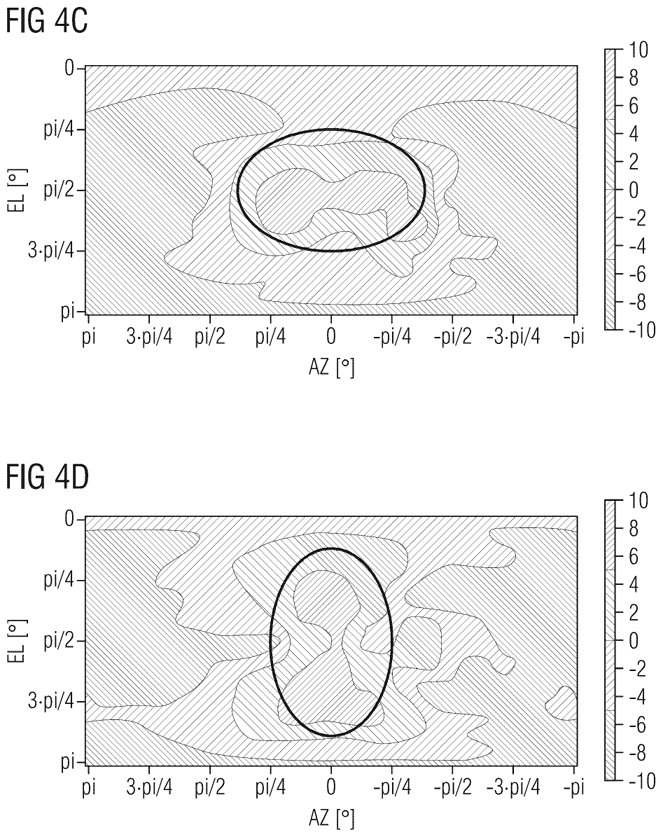

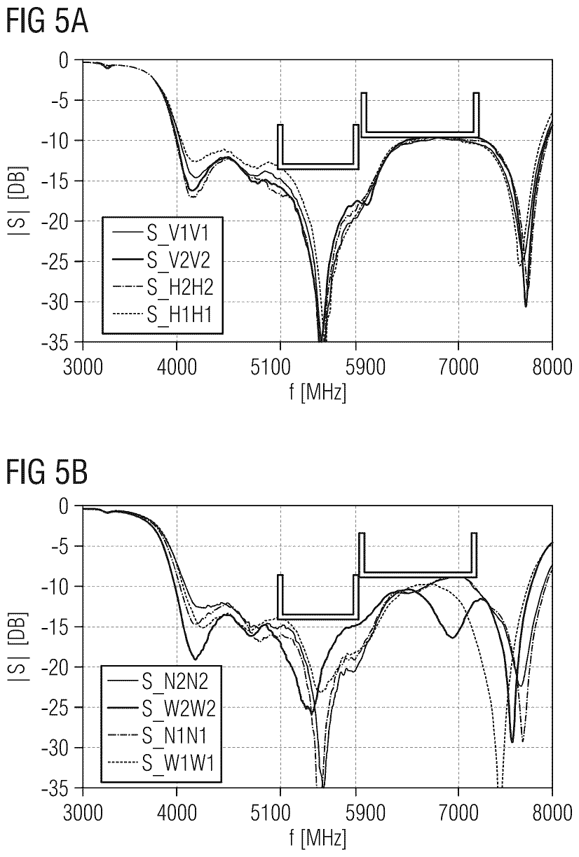

FIG. 3a is a spatial illustration of the antenna ANT with the antenna feed point SP. FIG. 3b is a spatial illustration of the circuit carrier at the transition between a matching circuit AS and a feed circuit ES. FIG. 3c is an illustration of simulated field strengths of the circuit carrier in the area of an antenna element. FIG. 3d is an illustration of the divider circuit TS comprising two electronically controllable impedances D1, D2 of the control circuit SS.

In each case, one of the two divider lines TL1, TL2 of the divider circuit TS is connected to the reference surface BF of the divider circuit TS, each via one of the two electronically controllable impedances D1, D2. The lines of the two divider lines TL1, TL2 are located on the first side of the circuit carrier, and the reference surface BF and the dipole DP are located on the second side of the circuit carrier.

The reference surface BF of the divider circuit TS has an electrically non-conductive dividing strip ST, i.e. a slot. The slot extends from between the output points AP1, AP2 to the two divider lines TL1, TL2 to the input point EP. Depending on the embodiment, the length of the slot can be only approximately the width of the dipole DP, or it can also extend to the input point EP.

The two PIN diodes D1, D2 are each arranged in opposite directions with respect to the reference surface BF and connected thereto, for example with a through-hole.

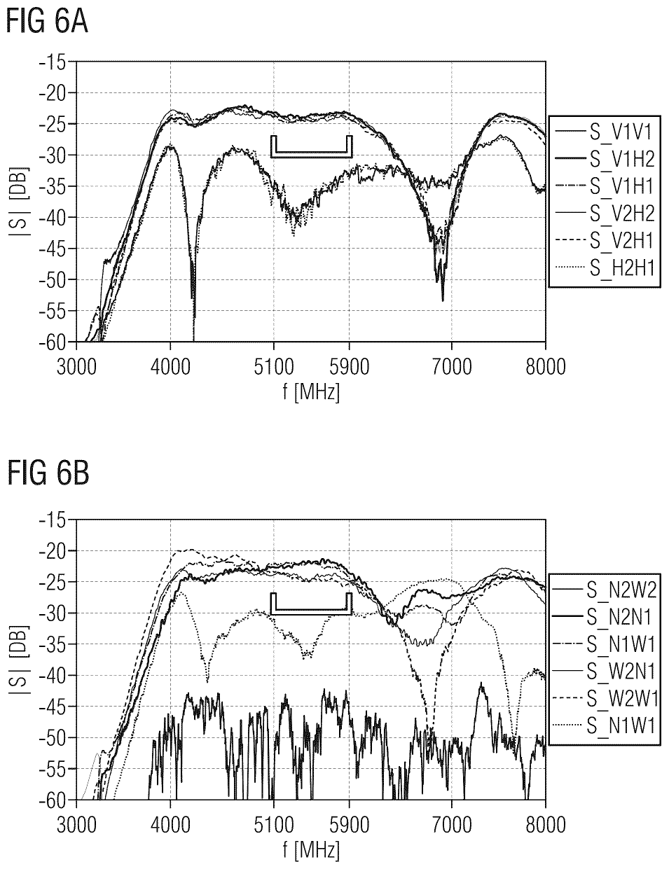

FIGS. 4a to FIG. 4d show radiation diagrams of the antenna with different radiation patterns.

The radiation diagrams of the antenna show the elevation over the azimuth angle, where four embodiments can be set for the respective radiation angle:
wide in azimuth and narrow in elevation
narrow in azimuth and wide in elevation
narrow in azimuth and narrow in elevation
wide in azimuth and elevation with a zero point in the normal axis of the dipoles

All four embodiments can be operated in two polarization modes. These embodiments cover a wide range of radiation patterns that are advantageous for different applications.

Furthermore, at least two such groups can be used to generate signals that offer a high degree of polarization and spatial diversity. This applies to each of the four adjustable radiation patterns. High diversity is crucial for modern wireless systems with MIMO functionality.

A narrow radiation pattern of the antenna can be identified in FIG. 4a. A wide radiation pattern of the antenna can be identified in FIG. 4b. A radiation pattern of the antenna in the form of a horizontal strip can be identified in FIG. 4c. A radiation pattern of the antenna in the form of a vertical strip can be identified in FIG. 4d.

Electronic switching of the radiation patterns and polarization modes makes it very easy to select the best antenna configuration; this can also occur after installation. The result is a controllable antenna in a small design that can be easily integrated into wireless products. Due to the high bandwidth, 5 GHz and 6 GHz WLAN can be covered with the same antenna, for example.

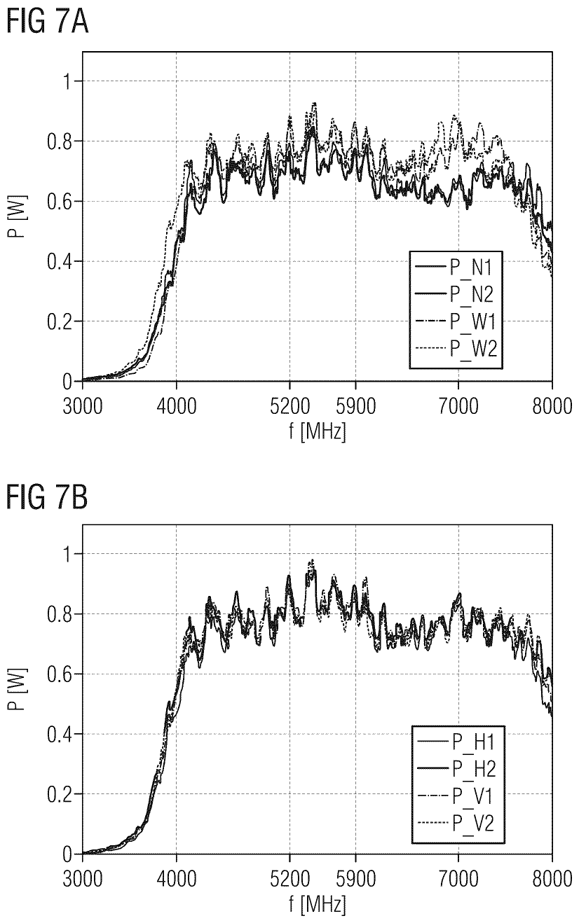

FIG. 5a and FIG. 5b are pass-through diagrams of the antenna in different radiation configurations. The desired frequency ranges for the target applications are also shown in the diagrams.

S pass-through parameters of the antenna in a strip configuration can be identified in FIG. 5a. The in/out S parameters between a first antenna (first part of the subscript) with vertical strip configurations V1, V2 or horizontal strip configuration H1, H2, and a second antenna (second part of the subscript) with vertical strip configurations V1, V2 or horizontal strip configuration H1, H2 are shown.

S pass-through parameters of the antenna in a narrow/wide configuration can be identified in FIG. 5b. The in/out S parameters between a first antenna (first part of the subscript) with a narrow configuration N1, N2 or wide configuration W1, W2, and a second antenna (second part of the subscript) with a narrow configuration N1, N2 or wide configuration W1, W2 are shown.

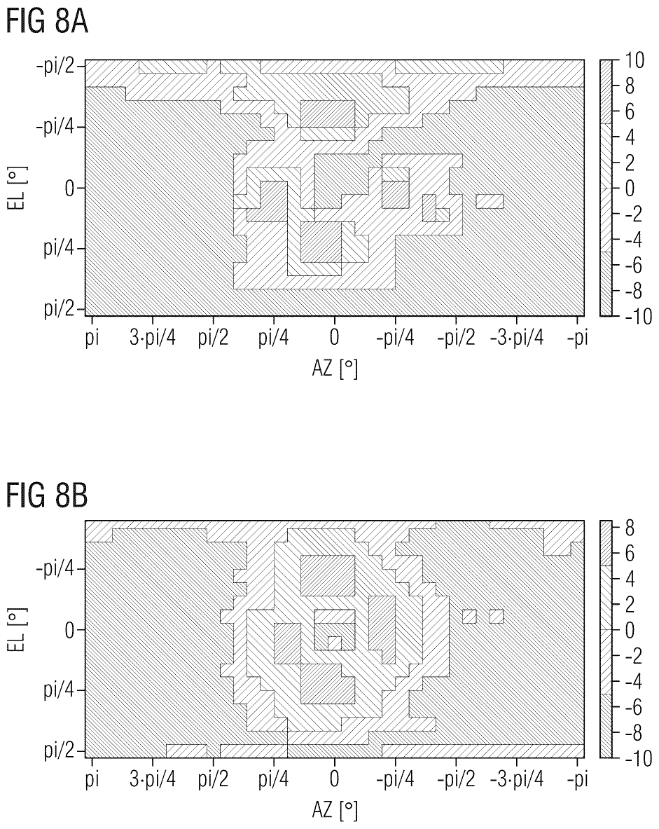

FIG. 6a and FIG. 6b show insulation diagrams of the antenna in different radiation configurations for an antenna bandwidth of approximately 4-7 GHz. S insulation parameters of the antenna in a strip configuration can be identified in FIG. 6a. S in/out parameters between a first antenna (first part of the subscript) with vertical strip configurations V1, V2 or horizontal strip configuration H1, H2, and a second antenna (second part of the subscript) with vertical strip configurations V1, V2 or horizontal strip configuration H1, H2 are shown.

Insulation S parameters of the antenna in a narrow/wide configuration can be identified in FIG. 6b. The S in/out parameters between a first antenna (first part of the subscript) with narrow configuration N1, N2 or wide configuration W1, W2, and a second antenna (second part of the subscript) with narrow configuration N1, N2 or wide configuration W1, W2 are shown.

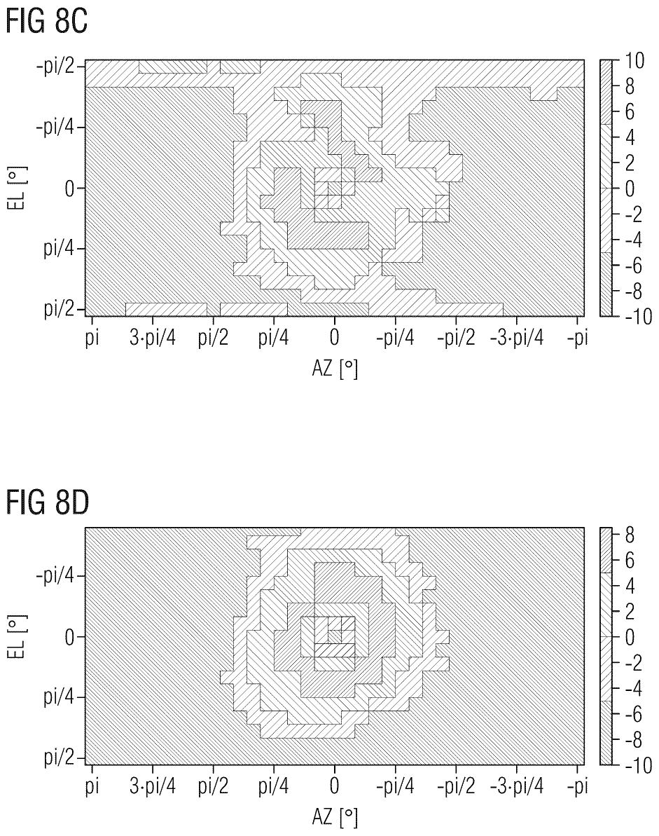

FIG. 7a and FIG. 7b show emitted power diagrams of the antenna in different radiation configurations for an antenna bandwidth of approximately 4-7 GHz.

Emitted antenna power in a narrow/wide configuration can be identified in FIG. 7a. This shows the powers for narrow antenna patterns N1, N2 and wide antenna patterns W1, W2.

Emitted antenna power in a strip configuration can be identified in FIG. 7b. This shows the powers for vertical strip configurations V1, V2 and horizontal strip configuration H1, H2.

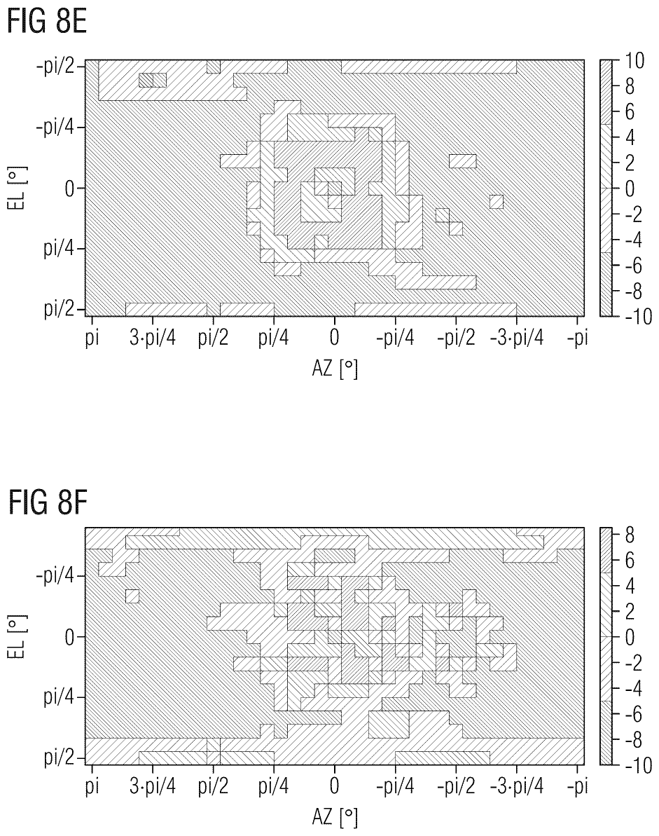

FIG. 8a to FIG. 8f are radiation diagrams of the antenna at different frequencies.

FIG. 8a shows a radiation field distribution at a frequency of 4 GHz. FIG. 8b shows a radiation field distribution at a frequency of 5.1 GHz. FIG. 8c shows a radiation field distribution at a frequency of 5.9 GHz. FIG. 8d shows a radiation field distribution at a frequency of 6.5 GHz. FIG. 8e shows a radiation field distribution at a frequency of 7.2 GHz. FIG. 8f shows a radiation field distribution at a frequency of 7.5 GHz.

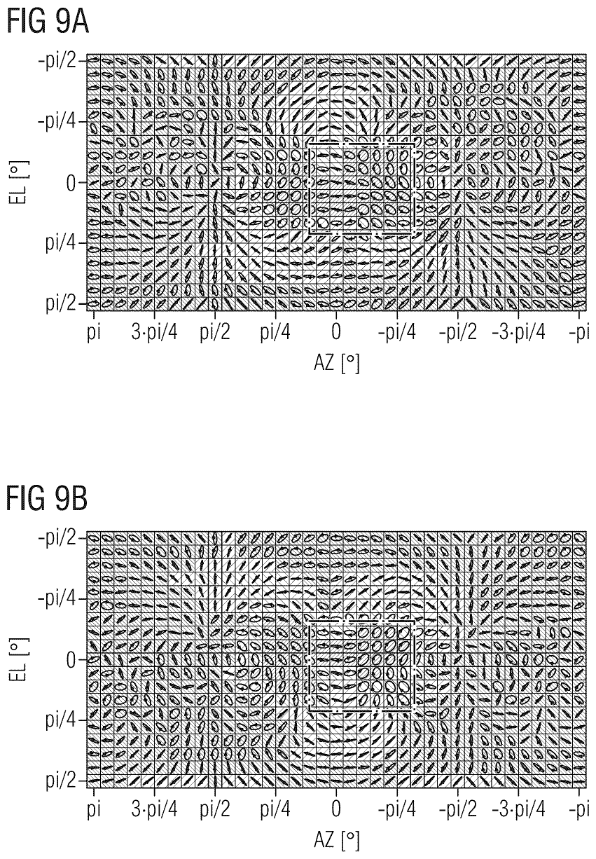

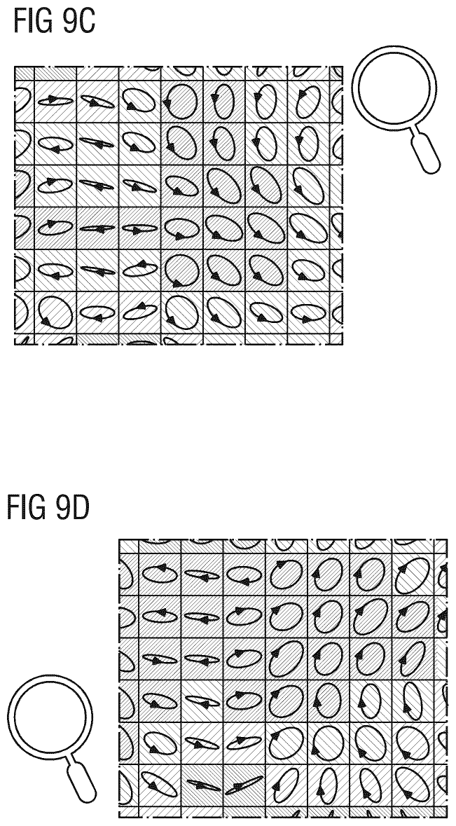

FIG. 9a and FIG. 9b show simulated field strength distributions of the antenna in different radiation configurations in which two spatially distributed maxima (“spatial diversity”) and different radiation patterns (“pattern diversity”) can be identified.

FIG. 9c and FIG. 9d show a magnified view of simulated field strength distributions in the preceding figures in which different polarizations (“polarization diversity”) can be identified, where the antennas have the same polarization or the opposite polarization (“left hand circular polarization”, LHCP, for short, or “right hand circular polarization”, RHCP for short).

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements that perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

### LIST OF REFERENCE SYMBOLS

AZ Azimuth
AE Antenna element, antenna path
AP1, AP2 Output point of the divider circuit
AS Matching circuit
BF Reference surface, mass
C Capacitor
DP Dipole antenna elements
EL Elevation
EP Input point of the divider circuit
ES Feed circuit
f Frequency
L1, L2 Coil
P, P_N1, P_N2, P_W1, P_W2 Radiated power in watts
SP Antenna feed point
SS Control circuit
TL1, TL2 Divider line
TV Divider connection line
TS Divider circuit
S_V1V1, S_V2V2, S_H1H1, S_H2H2, S_N1N1, S_N2N2, SW1W1, S_W2W2, S_V1V1, S_V1H2, S_V1H1, S_V2H2, S_V2H1, S_H2H1, S_N2W2, S_N2N1, S_N1W1, S_W2N1, S_W2W1, S_N1W1 S parameters
ST Dividing strip

What is claimed is:

1. A switchable broadband antenna having an antenna feed point for feeding in an input signal, the switchable broadband antenna comprising:
four antenna paths connected in parallel with respect to the antenna feed point, each of the four antenna paths having a matching circuit, a divider circuit, a control circuit and a dipole antenna element;
wherein in each case two dipole antenna elements are arranged in a first polarization direction, and a further two dipole antenna elements are arranged in a second polarization direction aligned normally to the first polarization direction;
wherein a respective matching circuit is configured to establish impedance matching for an input signal between the antenna feed point and the divider circuit;
wherein a respective divider circuit has two divider lines between an input point and two output points of the respective divider circuit with a common reference surface, and the respective divider circuit is further configured to symmetrically divide a signal provided to the input point via the matching circuit and to supply said signal to the respective output point of the respective divider circuit, which is connected to the respective dipole antenna element;
wherein the control circuit includes two electronically controllable impedances for which in each case at least two predetermined reflection factors is settable, each one of the two divider lines of the divider circuit being connected to the common reference surface of the respective divider circuit in each case via one of the two electronically controllable impedances, the two electronically controllable impedances each being arranged in opposite directions, and the control circuit being configured to provide respective control voltages to the respective electronically controllable impedances such that different reflection factors are set between the two electronically controllable impedances to switch the signal provided by the matching circuit and control an antenna pattern of the switchable broadband antenna.

2. The broadband antenna as claimed in claim 1, wherein, in a respective antenna path, the divider circuit is realized on a circuit carrier with a first side and a second side, and the two divider lines are arranged on the first side and the common reference surface is arranged on the second side.

3. The broadband antenna as claimed in claim 1 wherein, in a respective antenna path, the dipole antenna elements are also arranged on the circuit carrier of the divider circuit.

4. The broadband antenna as claimed in claim 1, wherein, in a respective antenna path, the dipole antenna elements are arranged on the second side of the circuit carrier.

5. The broadband antenna as claimed in the preceding claim 1, wherein, in a respective antenna path, the dipole antenna elements are connected to the reference surface of the divider circuit.

6. The broadband antenna as claimed in claim 1, wherein, in a respective antenna path, the reference surface of the divider circuit includes an electrically non-conductive dividing strip, which extends from between the two output points of the two divider lines to the input point.

7. The broadband antenna as claimed in claim 1, further comprising:
a feed circuit inserted into the respective antenna path to feed and control the two electronically controllable impedances of the control circuit.

8. The broadband antenna as claimed in claim 7, wherein the feed circuit in the divider circuit is inserted before the feed point into the respective antenna path.

9. The broadband antenna as claimed in claim 1, wherein, in a respective antenna path, the two output points of the divider circuit are each connected to the dipole antenna element via an ohmic resistor.

10. The broadband antenna as claimed in claim 1, wherein more than four antenna paths are arranged connected in parallel with respect to the antenna feed point, which each include the matching circuit, the divider circuit, the control circuit and the dipole antenna element.
